(19) United States
(12) Patent Application Publication
(10) Pub. No.: US 2019/0311353 A1
(43) Pub. Date: Oct. 10, 2019

(54) BLOCKCHAIN PAYMENT SYSTEM

(71) Applicant: Eric A. Solis, Palo Alto, CA (US)

(72) Inventor: Eric A. Solis, Palo Alto, CA (US)

(21) Appl. No.: 16/376,450

(22) Filed: Apr. 5, 2019

Related U.S. Application Data
(60) Provisional application No. 62/654,121, filed on Apr. 6, 2018.
(60) Provisional application No. 62/700,052, filed on Jul. 18, 2018.

(51) Int. Cl. G06Q 20/38; G06Q 20/36; G06Q 20/22; G06Q 20/32

(52) U.S. Cl. CPC G06Q 20/381; G06Q 20/363; G06Q 2220/00; G06Q 20/3223; G06Q 20/223

(57) ABSTRACT

A method for converting cryptocurrency into real, spendable currency includes receiving, from a first electronic device, a peer-to-peer payment request including a payment amount and a unique identifier of a recipient, generating a cryptocurrency payment invoice in response to receiving the peer-to-peer payment request, generating an invitation in response to payment of the cryptocurrency payment invoice, the invitation to be transmitted wirelessly to the recipient using the unique identifier, receiving, from a second electronic device, an acceptance of the invitation and one or more items of new user information associated with the recipient, generating a digital payment card in the name of the recipient in response to receiving the acceptance and the new user information, the digital payment card including a card number pulled from a bank identification number (BIN) range, and, after said generating the digital payment card, crediting the payment amount to the recipient.

### CROSS-REFERENCE TO RELATED APPLICATIONS

This application relates to and claims the benefit of U.S. Provisional Application No. 62/654,121, filed Apr. 6, 2018 and entitled “BLOCKCHAIN PAYMENT SYSTEM,” and U.S. Provisional Application No. 62/700,052, filed Jul. 18, 2018 and entitled “BLOCKCHAIN PAYMENT SYSTEM,” the entire disclosures of both of which are hereby incorporated by reference.

### STATEMENT RE: FEDERALLY SPONSORED RESEARCH/DEVELOPMENT

Not Applicable

### BACKGROUND

### 1. Technical Field

The present disclosure relates generally to virtual currency transactions and, more particularly, to converting cryptocurrency into real, spendable currency.

### 2. Related Art

Methods and systems for supporting peer-to-peer and customer-to-merchant virtual currency transactions are described in U.S. Pat. No. 10,127,528, entitled “Financial Services Ecosystem.” According to such methods and systems, a peer-to-peer payment request including a payment amount and a phone number, email address, or social network ID of a recipient may be received from a first mobile device and, in response to receiving the peer-to-peer payment request, an invitation may be generated to be transmitted wirelessly to the phone number, email address, or social network ID of the recipient. Thereafter, an acceptance of the invitation and one or more items of new user information associated with the recipient may be received from a second mobile device and, in response to receiving the acceptance and the new user information, a digital prepaid card may be generated in the name of the recipient and loaded with the payment amount. Such methods and systems may allow for the immediate conversion of virtual currency into real, spendable currency.

Meanwhile, there exist cryptocurrencies such as Bitcoin that have great value but for which there are limited means in place for easily tapping into such value.

### BRIEF SUMMARY

The present disclosure contemplates various systems, methods, and apparatuses for facilitating the integration of blockchain-based cryptocurrency (e.g. Bitcoin) into systems that support the immediate conversion of virtual currency into real, spendable currency. One embodiment of the present disclosure is a non-transitory program storage medium on which are stored instructions executable by a processor or programmable circuit to perform operations for converting cryptocurrency into real, spendable currency. The operations may include receiving, from a first electronic device, a peer-to-peer payment request including a payment amount and a unique identifier of a recipient, generating a cryptocurrency payment invoice in response to receiving the peer-to-peer payment request, generating an invitation in response to payment of the cryptocurrency payment invoice, the invitation to be transmitted wirelessly to the recipient using the unique identifier, receiving, from a second electronic device, an acceptance of the invitation and one or more items of new user information associated with the recipient, generating a digital payment card in the name of the recipient in response to receiving the acceptance and the new user information, the digital payment card including a card number pulled from a bank identification number (BIN) range, and, after said generating the digital payment card, crediting the payment amount to the recipient.

The unique identifier may be selected from the group consisting of a phone number, an email address, and a social network ID.

Generating the cryptocurrency payment invoice may include calling an API associated with a cryptocurrency payment processor.

Generating the digital payment card may include communicating the received peer-to-peer payment request and new user information to a payment processing platform and receiving the digital payment card from the payment processing platform.

Crediting the payment amount to the recipient may include loading the payment amount onto the digital payment card.

The digital payment card may be reloadable. The operations may further include receiving, from the second electronic device, a token request including a cash amount and generating a disposable digital card loaded with the cash amount in response to receiving the token request. Generating the disposable digital card may include communicating the received token request to a payment processing platform and receiving the disposable digital card from the payment processing platform.

The operations may further include storing a state associated with the cryptocurrency payment invoice in a permissioned blockchain framework. The state associated with the cryptocurrency payment invoice may include a paid/unpaid state of the cryptocurrency payment invoice.

The operations may further include storing a state associated with the invitation in a permissioned blockchain framework. The state associated with the invitation may include an accepted/unaccepted state of the invitation.

The operations may further include storing a state associated with the digital payment card in a permissioned blockchain framework. The state associated with the digital payment card may include an amount loaded onto the digital payment card.

Another embodiment of the present disclosure is a method for converting cryptocurrency into real, spendable currency. The method may include receiving, from a first electronic device, a peer-to-peer payment request including a payment amount and a unique identifier of a recipient, generating a cryptocurrency payment invoice in response to receiving the peer-to-peer payment request, generating an invitation in response to payment of the cryptocurrency payment invoice, the invitation to be transmitted wirelessly to the recipient using the unique identifier, receiving, from a second electronic device, an acceptance of the invitation and one or more items of new user information associated with the recipient, generating a digital payment card in the name of the recipient in response to receiving the acceptance and the new user information, the digital payment card including a card number pulled from a bank identification number (BIN) range, and, after said generating the digital payment card, crediting the payment amount to the recipient.

The unique identifier may be selected from the group consisting of a phone number, an email address, and a social network ID.

Another embodiment of the present disclosure is a system for converting cryptocurrency into real, spendable currency. The system may include a first electronic device that wirelessly transmits a peer-to-peer payment request including a payment amount and a unique identifier of a recipient, one or more servers that receive the peer-to-peer payment request, generate a cryptocurrency payment invoice in response to receiving the peer-to-peer payment request, and generate an invitation in response to payment of the cryptocurrency payment invoice, the invitation to be transmitted wirelessly to the recipient using the unique identifier, and a second electronic device that receives the invitation and wirelessly transmits an acceptance of the invitation and one or more items of new user information associated with the recipient. The one or more servers may receive the acceptance and the new user information, generate a digital payment card in the name of the recipient in response to receiving the acceptance and the new user information, and, after generating the digital payment card, credit the payment amount to the recipient. The digital payment card may include a card number pulled from a bank identification number (BIN) range.

The unique identifier may be selected from the group consisting of a phone number, an email address, and a social network ID.

The system may further include a cryptocurrency payment processor, and the one or more servers may generate the cryptocurrency payment invoice by calling an API associated with the cryptocurrency payment processor.

The one or more servers may comprise a permissioned blockchain framework.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example blockchain payment apparatus according to an embodiment of the present disclosure;

FIG. 2 shows an example view of a blockchain payment graphical user interface (GUI) including a cryptocurrency payment invoice;

FIGS. 3, 3A, and 3B show an example operational flow according to an embodiment of the present disclosure, with FIG. 3 being a diagram showing the arrangement of the partial views shown in FIGS. 3A and 3B;

FIG. 4 shows an example high level architecture of a permissioned blockchain framework of the blockchain payment apparatus;

FIGS. 5, 5A, and 5B show an example deployment view of the architecture of FIG. 4, with FIG. 5 being a diagram showing the arrangement of the partial views shown in FIGS. 5A and 5B;

FIG. 6 shows another example operational flow according to an embodiment of the present disclosure; and

FIG. 7 shows an example of a computer in which the blockchain payment apparatus of FIG. 1, the operational flows of FIGS. 3, 3A, 3B, and 6, and/or other embodiments of the disclosure may be wholly or partly embodied.

### DETAILED DESCRIPTION

The present disclosure encompasses various embodiments of systems, methods, and apparatuses for converting cryptocurrency into real, spendable currency. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

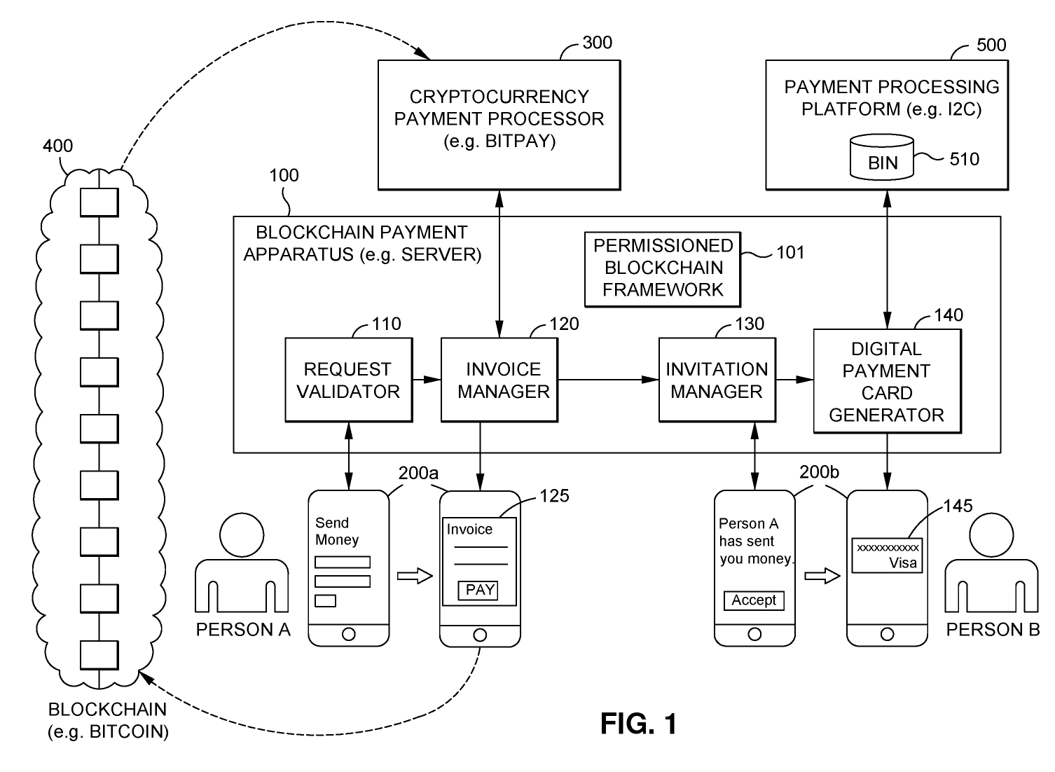

FIG. 1 shows an example blockchain payment apparatus 100 according to an embodiment of the present disclosure. The blockchain payment apparatus 100 may be a server or a combination of networked servers that interacts with a web browser or mobile application of one or more user devices 200a, 200b, a cryptocurrency payment processor 300 such as BitPay, and a payment processing platform such as the Agile Payments processing platform by i2C Inc. In the example of FIG. 1, a first user of the blockchain payment apparatus 100, Person A, would like to use his/her cryptocurrency (e.g. Bitcoin) to send money to a second user, Person B. Both Person A and Person B may be new users in the sense that they are unfamiliar with and have no account with the provider of the blockchain payment apparatus 100. Moreover, Person B might not own any cryptocurrency and might not have a cryptocurrency wallet. In response to Person A's request to send money, the blockchain payment apparatus 100 may convert cryptocurrency such as Bitcoin belonging to Person A into real currency in the form of a digital payment card 145 that is spendable by Person B. The blockchain payment apparatus 100 may include a request validator 110, an invoice manager 120, an invitation manager 130, and a digital payment card generator 140. The blockchain payment apparatus 100 may further include a permissioned blockchain framework 101 in which some or all of the blockchain payment apparatus 100 may be implemented.

The request validator 110 may receive, from a first electronic device 200a, a peer-to-peer (P2P) payment request including a payment amount and a unique identifier of a recipient, for example, a phone number, email address, or social network ID of the recipient. Other unique identifiers are contemplated as well, such as biometric data (e.g. a fingerprint), a public key associated with a blockchain, etc. The request validator 110 may record the received payment request in the permissioned blockchain framework 101. Person A may operate the first electronic device 200a to make the payment request using a graphical user interface (GUI) accessible on a website or mobile application of the provider of the blockchain payment apparatus 100. Such a GUI (e.g. “Send Money” in FIG. 1) may include for example, a field for a payment amount and one or more fields for recipient information, such as a phone number, an email address, or a social network ID. The GUI may further include additional fields for identifying the sender in a case that the sender is a new user and thus not already identified by virtue of having logged in to the GUI, as well as for identifying a source of funds from among those supported by the blockchain payment apparatus 100. In the example of FIG. 1, Person A inputs into the GUI a payment amount and the email address of the recipient, Person B, indicates that payment will be made using cryptocurrency, and submits the information as a payment request. The request validator 110 may validate one or more aspects of the received request as described in more detail below. Such validation may be made against data stored in the permissioned blockchain framework 101.

The invoice manager 120 may generate a cryptocurrency payment invoice 125 in response to the receipt of the payment request by the blockchain payment apparatus 100. The invoice manager 120 may store the cryptocurrency invoice 125 and various states thereof in the permissioned blockchain framework 101. Continuing with the above example, the blockchain payment apparatus 100 has received a payment request from Person A to send cryptocurrency to Person B. After the request validator 110 has validated the payment request, the invoice manager 120 may communicate with a cryptocurrency payment processor 300 such as BitPay to generate a cryptocurrency payment invoice 125, for example, by calling an API associated with the cryptocurrency payment processor 300. The payment address of the cryptocurrency payment invoice 125 may be a cryptocurrency account associated with the provider of the blockchain payment apparatus 100. The cryptocurrency payment invoice 125 may then be presented to Person A on the GUI to be accessed by Person A using the electronic device 200a. The cryptocurrency payment invoice 125 may be, for example, a BitPay invoice and may include, in addition to the payment amount, a QR code encoding the payment address, the payment address itself to be copied and pasted, and/or a link to populate the payment address directly to a cryptocurrency wallet on the same electronic device 200a. After presenting the cryptocurrency payment invoice 125 to Person A, the invoice manager 120 may then await payment of the cryptocurrency payment invoice 125 while at the same time the blockchain payment apparatus 100 stores a record of the payment amount in association with the unique identifier of the recipient, i.e. Person B, in this case Person B's email address. Such record may be stored in the permissioned blockchain framework 101.

The invitation manager 130 may generate an invitation in response to payment of the cryptocurrency payment invoice 125, the invitation to be transmitted wirelessly to the recipient using the unique identifier, e.g., the phone number, email address, or social network ID of the recipient. The invitation manager 130 may store the invitation and various states thereof in the permissioned blockchain framework 101. Continuing with the above example, Person A may pay the cryptocurrency payment invoice 125, for example, by authorizing payment using a cryptocurrency wallet on the same electronic device 200a. The payment by Person A may then be recorded to a blockchain 400 associated with the cryptocurrency (e.g. a Bitcoin blockchain), for example, by operation of Person A's cryptocurrency wallet. Once the cryptocurrency payment invoice 125 is paid, for example, as established by a predetermined number of confirmations on the blockchain 400, the blockchain payment apparatus 100 or the cryptocurrency payment processor 300 may reflect the “paid” status to the cryptocurrency payment invoice 125, in response to which the invoice manager 120 may update the record of the payment request (e.g. in the permissioned blockchain framework 101) to reflect that the cryptocurrency payment invoice 125 has been paid. In response to such update, the invitation manager 130 may generate the invitation, which may be in the form of a text message, email, social network message, etc., depending on the recipient information on record. In the above example, Person A's payment request included Person B's email address, so the invitation generated by the invitation manager 130 may be an email including a message (e.g. “Person A has sent you money”) as well as additional details including the amount of money and various instructions as well as terms and conditions. The blockchain payment apparatus 100 may then send such email invitation to Person B's email address.

Upon receiving the invitation from the blockchain payment apparatus 100, for example, on a second electronic device 200b, Person B may accept the invitation, e.g., by pressing an “Accept” button linking to a website or mobile application download site. In order to receive the payment, Person B may then be required by the provider of the blockchain payment apparatus 100 to provide one or more items of new user information in order to comply with know your customer (KYC) guidelines, as well as to accept terms and conditions, register with the provider of the blockchain payment apparatus 100, etc. The invitation manager 130 may thus receive, from the second electronic device 200b, an acceptance of the invitation and one or more items of new user information associated with the recipient. The invitation manager 130 may record the acceptance and new user information in the permissioned blockchain framework 101.

The digital payment card generator 140 may generate a digital payment card 145 in the name of the recipient in response to receiving the acceptance of the invitation and the new user information. The digital payment card 145 may include a card number pulled from a bank identification number (BIN) range 510. For example, with the cryptocurrency payment invoice 125 having been paid by Person A and the invitation having been accepted by Person B, the digital payment card generator 140 may communicate the payment request and the new user information associated with Person B to a payment processing platform 500 such as the Agile Payments processing platform by i2C Inc. The digital payment card generator 140 may then receive the digital payment card 145 from the payment processing platform 500, the digital payment card 145 including a card number pulled from a bank identification number (BIN) range 510.

After generating the digital payment card 145, the digital payment card generator 140 may credit the payment amount to the recipient, for example, by loading the amount of the payment request onto the digital payment card 145. States associated with the digital payment card 145, including generation thereof and crediting the payment amount to the recipient, may be recorded in the permissioned blockchain framework 101. The digital payment card generator 140 may then present the digital payment card 145 to Person B, for example, using a website or mobile application GUI accessible to Person B on the second electronic device 200b. As shown in FIG. 1, the digital payment card 145 may be an image of a VISA® card or other major network card and may include the card number, an expiration date, and a security code (e.g. card verification value). The money loaded on the digital payment card 145 is real, spendable currency that can immediately be spent by Person B, avoiding any need to transfer cryptocurrency or virtual currency to a checking account or other like transaction that is not completed in real time.

In the example shown in FIG. 1, the cryptocurrency payment processor 300 is depicted as a third-party processor and, in particular, BitPay. However, the disclosed subject matter is not intended to be so limited. For example, other third-party processors may be used besides BitPay. Moreover, the cryptocurrency payment processor 300 may not be a third-party processor at all and may itself be part of the blockchain payment apparatus 100 and controlled by the same provider entity. States associated with the functionality of the cryptocurrency payment processor 300 may be recorded in the permissioned blockchain framework 101.

Along the same lines, in the example shown in FIG. 1, the payment processing platform 500 is depicted as a third-party processing platform and, in particular, an i2C processing platform. However, the disclosed subject matter is not intended to be so limited. For example, other third-party processing platforms may be used besides i2C processing platforms. Moreover, the payment processing platform 500 may not be a third-party processing platform at all and may itself be part of the blockchain payment apparatus 100 and controlled by the same provider entity. States associated with the functionality of the payment processing platform 500 may be recorded in the permissioned blockchain framework 101.

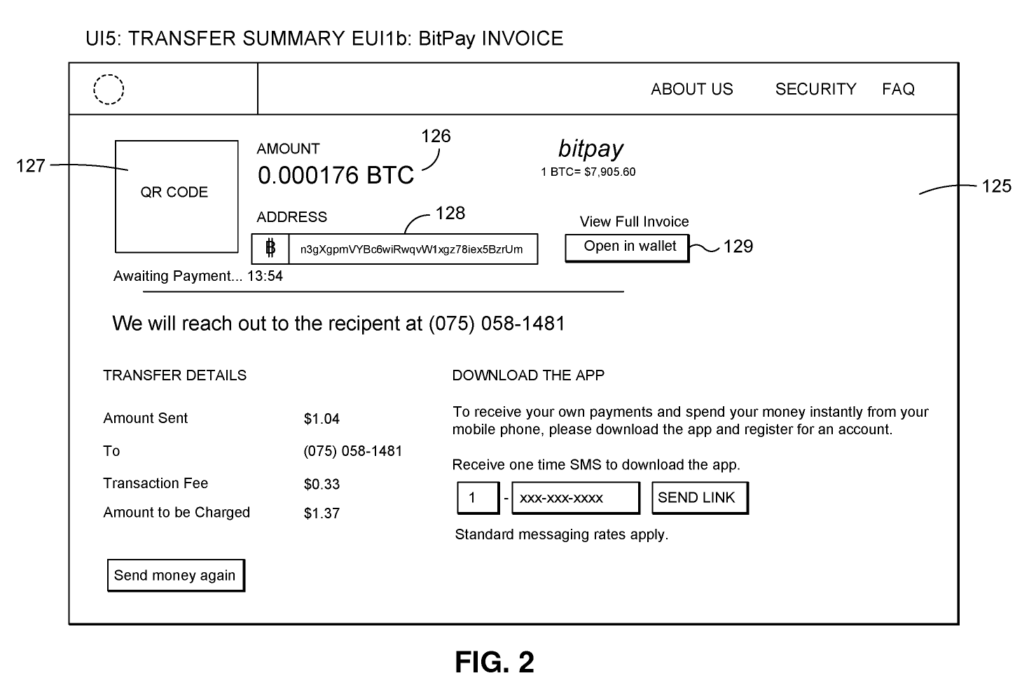

FIG. 2 shows an example view of a blockchain payment graphical user interface (GUI) including the cryptocurrency payment invoice 125. The blockchain payment GUI of FIG. 2 may be displayed on the electronic device 200a (e.g. mobile phone) of Person A when Person A requests to make a payment using cryptocurrency. As shown in FIG. 2, the cryptocurrency payment invoice 125 may include the payment amount 126, a QR code 127 encoding the payment address, the payment address 128 itself to be copied and pasted, and/or a link 129 to populate the payment address directly to a cryptocurrency wallet on the same electronic device 200a. As shown, the cryptocurrency payment invoice 125 may further include transfer details showing, for example, the amount sent in real currency, the phone number, email address, or social network ID of the recipient, any transaction fee charged by the provider of the blockchain payment apparatus 100, the total amount to be incurred by the sender including such fees, etc.

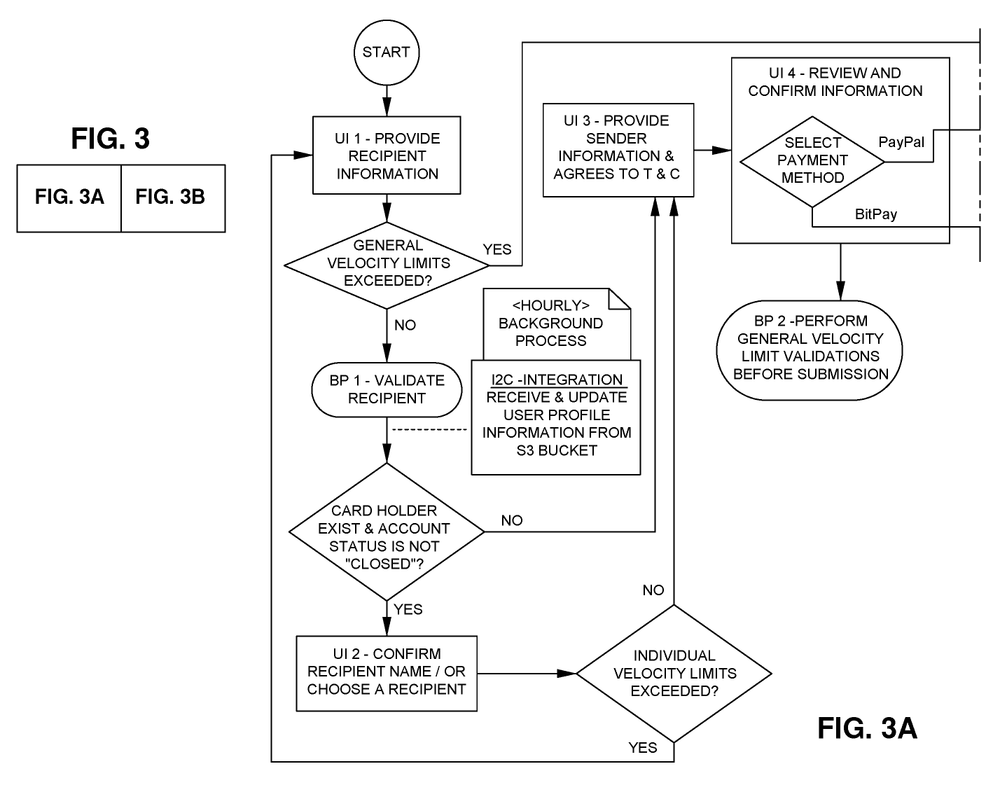

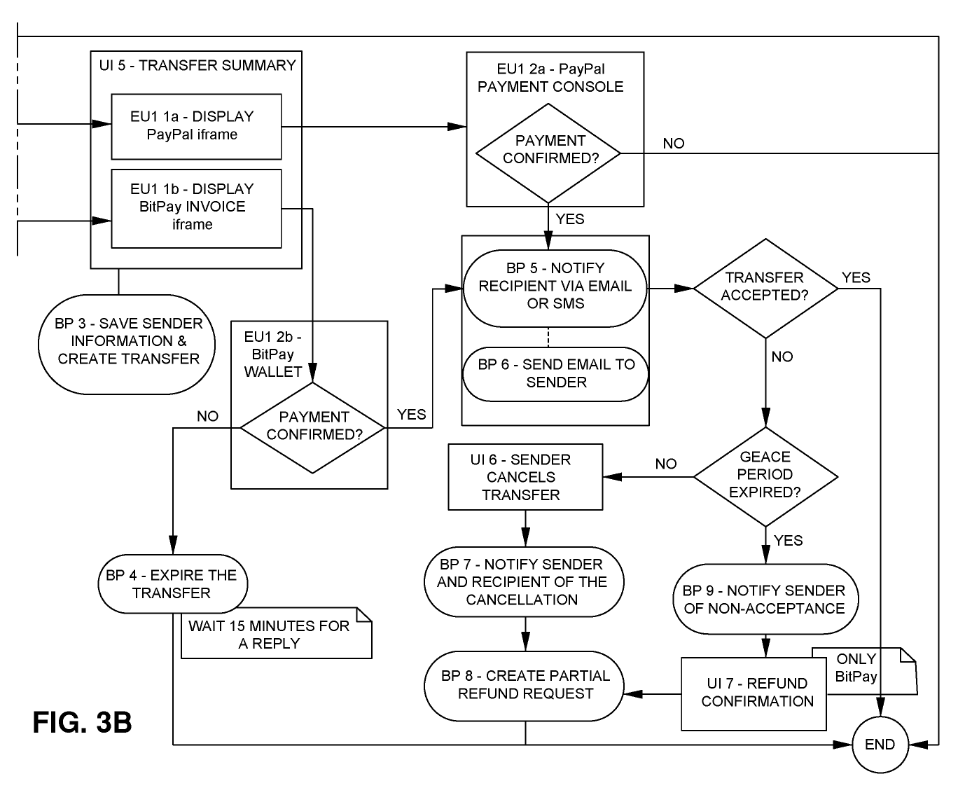

FIGS. 3, 3A, and 3B show an example operational flow according to an embodiment of the present disclosure, with FIG. 3 being a diagram showing the arrangement of the partial views shown in FIGS. 3A and 3B. The operational flow shown in FIGS. 3, 3A, and 3B may be performed by the blockchain payment apparatus 100 shown and described in relation to FIG. 1. The operational flow begins with a step UI1 in which recipient information is provided. For example, in the context of the blockchain payment apparatus 100, the request validator 110 may capture, based on Person A's interaction with a GUI on the first electronic device 200a, the phone number, email address, or social network ID of the recipient as well as the payment amount and an optional note for the recipient. At this stage, Person A may be informed of a transaction fee to be charged on top of the payment amount entered. The request validator 110 may then check whether general velocity limits are exceeded by the payment, for example, whether a maximum per-day payment amount (e.g. $5000) and/or a maximum per-transaction payment amount (e.g. $300) are exceeded. If general velocity limits are exceeded, Person A may be informed via the GUI and the process flow may end without fulfilling the payment request.

If general velocity limits are not exceeded, the operational flow may continue with a step BP1 of validating the recipient of the payment request. For example, the request validator 110 may validate the recipient details of the request (e.g. phone number, email address, social network ID) against existing user information. Such existing user information may, for example, be periodically retrieved in a log file from the payment processing platform 500, which may store all user updates including new user registrations, information/status updates to existing users, etc. The request validator 110 may then validate the recipient against such existing user information, for example, by checking whether the recipient is already an active user. If not, i.e. if the user does not exist or the user's status is closed, the operational flow may proceed to step UI3, discussed below. If, on the other hand, the recipient is an active user, the operational flow may proceed to step UI2, where the sender may be given an opportunity to confirm the recipient's name or choose the recipient from among similarly named users using the GUI. If the selected recipient's account is unavailable because it is blocked (e.g. due to inactivity or fraud), the sender may be informed and the transaction denied. The request validator 110 may further check whether individual recipient velocity limits are exceeded for the selected existing user, for example a per-day maximum transaction amount (e.g. $300), in which case the GUI may navigate back to UI1 allowing the sender to enter a different recipient.

In step UI3, the send may be prompted to enter certain information, such as the sender's name and email, using the GUI. The sender may further be required to agree to terms and conditions. As noted above, the sender, like the recipient, need not be a previously registered user of the blockchain payment apparatus 100. Therefore, step UI3 may serve to identify the sender to the blockchain payment apparatus 100 as well as to the recipient. In a case where the sender is already a registered user of the blockchain payment apparatus 100, the sender may already be logged in to the GUI, in which case step UI3 may be omitted.

Continuing with a step UI4, the GUI may allow the sender to select a payment method and/or source of funds. As noted above, payment by various methods may be supported by the cryptocurrency payment apparatus 100, including non-cryptocurrency methods such as PayPal®. For purposes of the present example, it is assumed that the sender selects cryptocurrency (e.g. Bitcoin) as the payment method, after which velocity limits may again be validated by the request validator 110 as part of a final confirmation. In the remainder of the operational flow shown in FIGS. 3, 3A, and 3B, the cryptocurrency payment processor 300 is referred to as BitPay for convenience, but, as noted above, the blockchain payment apparatus 100 is not limited to using BitPay as the cryptocurrency payment processor 300, nor is the cryptocurrency payment processor 300 necessarily a third-party processor.

Upon selection of cryptocurrency as the payment method, the operational flow may, in a step UI5, proceed with displaying a cryptocurrency invoice 125 in the GUI (e.g. on the sender's electronic device 200a). For example, the invoice manager 120 of the blockchain payment apparatus 100 may generate the cryptocurrency invoice 125 by calling an API associated with the cryptocurrency payment processor 300, and the sender may be navigated to an iFrame displaying the cryptocurrency invoice 125. As shown in FIG. 2, in addition to the payment amount 126 and means 127, 128, 129 for paying the invoice 125, the cryptocurrency invoice 125 may further include transfer details, a link to download an app provided by the provider of the blockchain payment apparatus 100, etc. The transfer details may further be stored in a step BP3, after which the invoice manager 120 may await payment of the cryptocurrency invoice 125. Storing the sender information as part of the transfer details may allow the blockchain payment apparatus 100 to keep track of repeated attempts to send money by the same person.

With the cryptocurrency invoice 125 having been presented to the sender, the operational flow continues with a step EU1 2b of confirming payment of the cryptocurrency invoice 125, which may be authorized by the sender using a cryptocurrency wallet as described above. If payment is not confirmed, the transfer may be set to expire, e.g. after fifteen minutes, in a step BP4. The sender may receive a notification of the failed transfer, for example, by email. If, on the other hand, payment is confirmed, for example, by the receipt of a transaction ID produced by the blockchain 400, the state of the invoice stored in the blockchain payment apparatus 100 may be updated to “PAID” (e.g. by the invoice manager 120) and the operational flow may proceed to steps BP5 and BP6.

In step BP5, the recipient is notified of the payment. For example, in the case of an existing user of the blockchain payment apparatus 100, the recipient may simply be notified that the sender has sent money to their account and an existing digital payment card 145 (which may be reloadable) may be credited with the amount of the payment. On the other hand, in the case of a new user, the invitation manager 130 may generate an invitation as described above and deliver the invitation to the recipient using an email address, mobile phone number, or other unique identifier provided by the sender. If the transfer is accepted by the recipient within some specified grace period (e.g. 72 hours), the operational flow ends. The invitation manager 130 may then store the new user information provided by the recipient and the digital payment card generator 140 may generate the digital payment card 145 for the recipient and credit the payment amount to the recipient as described above. If, on the other hand, the grace period expires, the sender may be notified of the recipient's non-acceptance in a step BP9 and, in the case of a cryptocurrency payment, asked to confirm the initiation of a refund in a step UI7. The operational flow may proceed to a step BP8 of creating a partial refund request.

In step BP6, at or around the time that the recipient is notified of the payment, the sender may be sent a notification (e.g. email) containing a transfer summary. In the case of a new user recipient, the notification may inform the sender that the recipient has been contacted regarding the payment and that non-acceptance within the specified grace period will result in a refund. At any time during the grace period, the sender may cancel the transfer in a step UI6, for example, using a link provided in the notification of step BP6. Upon the cancelation of the transfer by the sender, the sender and recipient may be notified of the cancellation in a step BP7 and the operational flow may proceed to step BP8.

In step BP8, the sender may be prompted by the GUI to enter the sender's own cryptocurrency payment address (e.g. wallet address) to which cryptocurrency will be refunded. The refund may be a partial refund in that it may exclude a transaction fee collected by the provider of the blockchain payment apparatus 100. Upon completion of the refund request, the blockchain payment apparatus 100 may initiate a cryptocurrency payment to the sender's payment address to refund or partially refund the amount of the non-accepted or cancelled transfer.

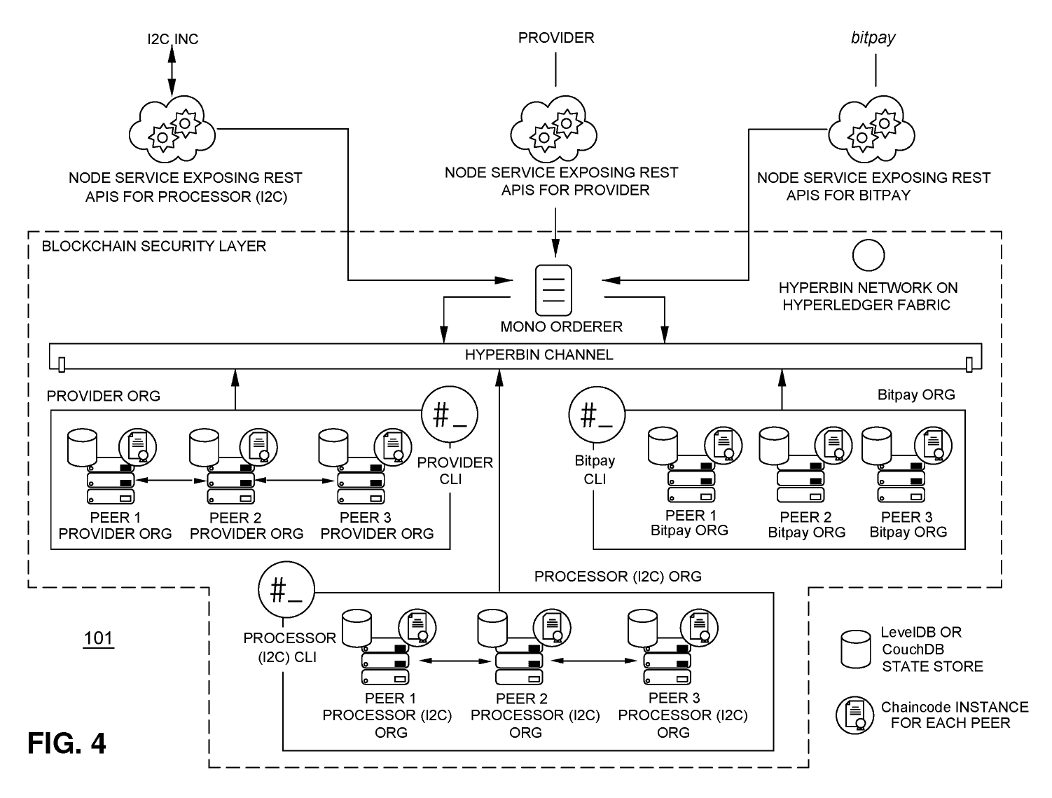

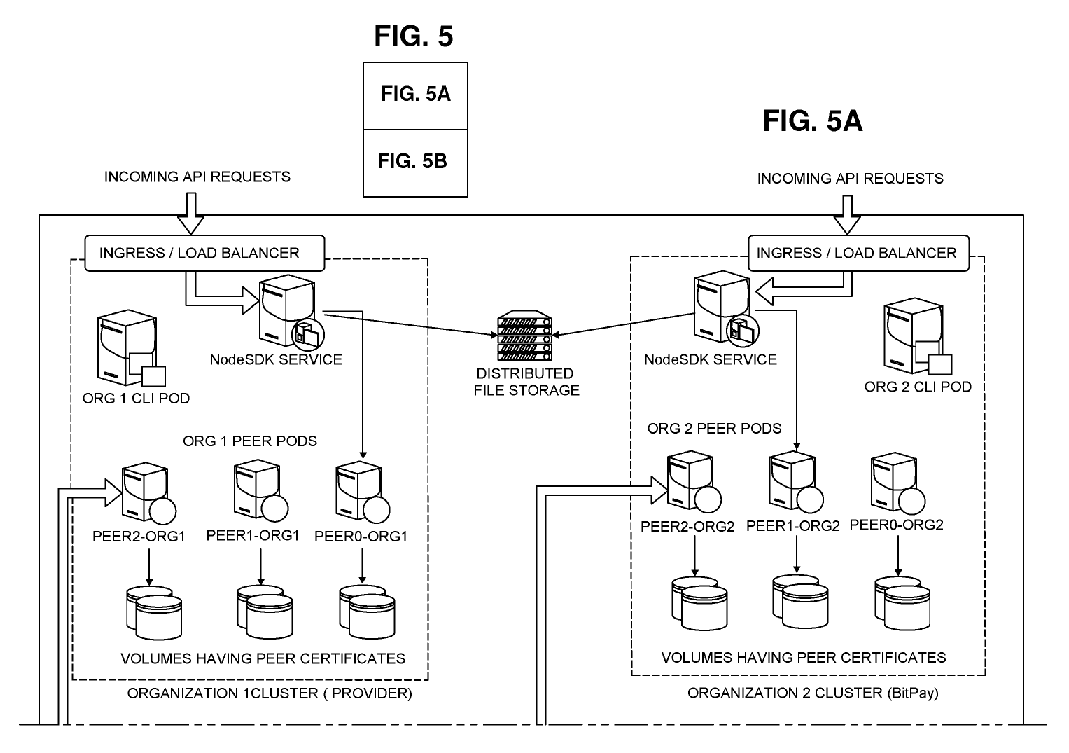

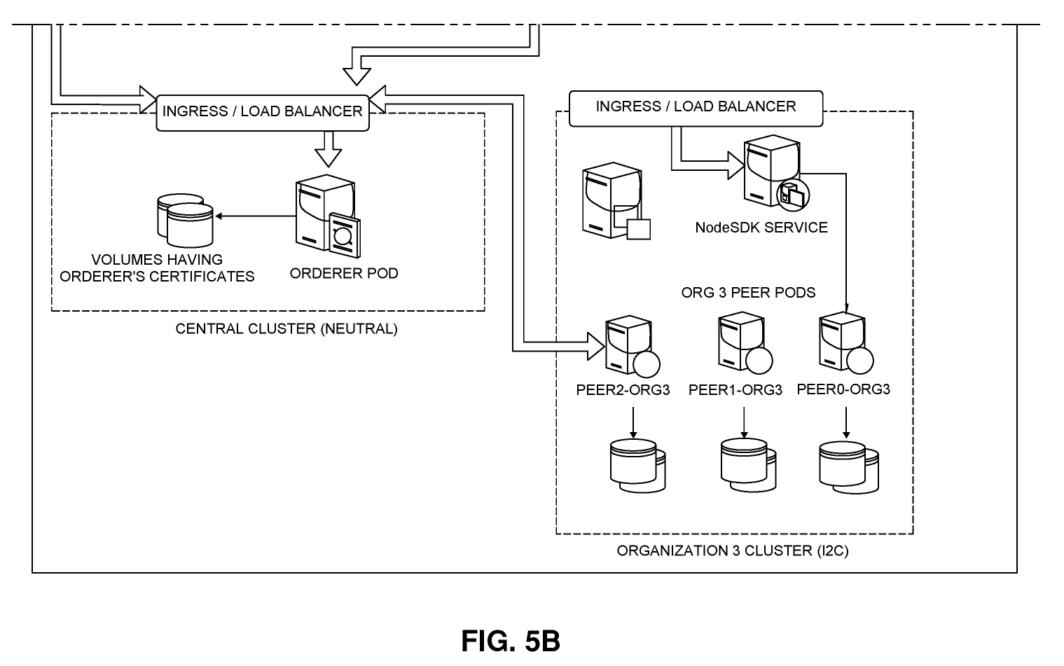

FIG. 4 shows an example high level architecture of the permissioned blockchain framework 101 of the blockchain payment apparatus 100. FIGS. 5, 5A, and 5B show an example deployment view of the architecture of FIG. 4, with FIG. 5 being a diagram showing the arrangement of the partial views shown in FIGS. 5A and 5B. As shown in FIGS. 4, 5, 5A, and 5B, the blockchain payment apparatus 100 may be implemented in a permissioned blockchain framework 101 such as The Linux Foundation's Hyperledger Fabric. Each state change tracked by the blockchain payment apparatus 100 may be immutably stored within the blockchain framework 101 and thereafter relied upon by the blockchain payment apparatus 100 upon peer consensus. Such state changes may include, for example, receipt of payment requests by the request validator 110, sender/amount/recipient validation states, generation of cryptocurrency invoices 125 by the invoice manager 120, receipt of transaction IDs produced by the blockchain 400 indicating invoice payment, paid/unpaid states of cryptocurrency payment invoices 125, generation of invitations by the invitation manager 130, receipt and validation of the recipient's acceptance and new user information, accepted/non-accepted states of invitations, generation of digital payment card 145 by the digital payment card generator 140, crediting of the payment amount to the digital payment card 145, an amount loaded onto the digital payment card 145, etc. As shown in FIGS. 4, 5, 5A, and 5B, the blockchain framework 101 may include a plurality of organizations corresponding to members of the blockchain framework 101, for example, one organization corresponding to the provider of the blockchain payment apparatus 100, another corresponding to the cryptocurrency payment processor 300, and another corresponding to the payment processing platform 500, each organization including a plurality of peers with associated state stores and chaincode instances. In the illustrated example, there are three organizations and each of the organizations has three such peers, for a total of nine peers connected to a tenth orderer peer over a communication channel. The members can transact with the blockchain framework 101 via the orderer peer, for example, using node services exposing REST APIs. Owing to the use of a permissioned blockchain framework 101 as shown in the example architecture of FIGS. 4, 5, 5A, and 5B, the blockchain payment apparatus 100 may securely track states associated with user payment transactions involving conversions between cryptocurrency, virtual currency, and real, spendable currency.

In the example of FIGS. 4, 5, 5A, and 5B, a single public channel is shared by the provider of the blockchain payment apparatus 100, the cryptocurrency payment processor 300, and the payment processing platform 500. However, other channel configurations for the blockchain framework 101 are contemplated as well, such as a pair of private channels respectively connecting the blockchain payment apparatus 100 to the cryptocurrency payment processor 300 and the payment processing platform 500, or a combination of the public channel with such a pair of private channels.

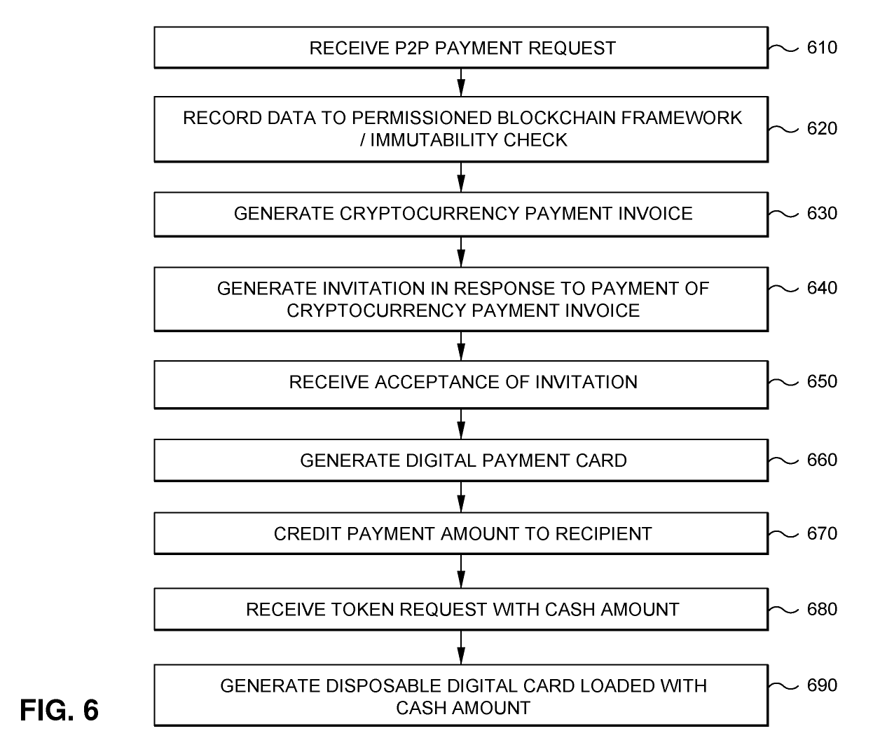

FIG. 6 shows another example operational flow according to an embodiment of the present disclosure. The operational flow shown in FIG. 6 may be performed by the blockchain payment apparatus 100 shown and described in relation to FIG. 1 to convert cryptocurrency (e.g. Bitcoin) belonging to person A into real, spendable currency belonging to Person B. The operational flow may begin with the receipt of a peer-to-peer payment request from Person A (step 610), recordation of data associated therewith to the permissioned blockchain framework 101 (step 620), and generation of a cryptocurrency payment invoice 125 (step 630). It should be noted that the order of the steps is not critical and that, in particular, the recording of data to the permissioned blockchain framework 101, as well as referencing data stored in the permissioned blockchain framework 101 and checking immutability thereof, may occur not only between steps 610 and 630 but at various points throughout the operational flow of FIG. 6 as described above in relation to the blockchain payment apparatus 100. In response to payment of the cryptocurrency payment invoice 125 by Person A, the operational flow may continue with the generation of an invitation to Person B to receive the payment (step 640) and the receipt by the blockchain payment apparatus 100 of Person B's acceptance and accompanying new user information (step 650). Steps 610-650 may be performed by the blockchain payment apparatus 100 as described in relation to FIGS. 1, 3, 3A, and 3B.

With the blockchain payment apparatus 100 having received the acceptance of the invitation (i.e. acceptance of the payment transfer) and new user information of Person B, the operational flow may proceed to a step of generating a digital payment card 145 (step 660). For example, in response to the invitation manager 130 of the blockchain payment apparatus 100 having updated the state of the invitation to “ACCEPTED” and received the new user information, the digital payment card generator 140 may provide the information of the payment request including the new user information associated with Person B to the payment processing platform 500, which may pull a card number from a BIN range 510. The digital payment card generator 140 may then receive the digital payment card 145 from the payment processing platform 500.

After generating the digital payment card 145, the digital payment card generator 140 may credit the payment amount to the recipient (step 670), for example, by loading the amount of the payment request onto the digital payment card 145. The digital payment card generator 140 may then present the digital payment card 145 to Person B, for example, via a GUI on Person B's device 200b. Person B may then immediately spend the digital payment card 145 anywhere that accepts cards pulled from the BIN range 510. For example, in the case of a BIN range 510 of VISA® card numbers, Person B may spend the digital payment card 145 anywhere that accepts VISA® cards. In the case of a BIN range 510 of MasterCard® card numbers, Person B may spend the digital payment card 145 anywhere that accepts MasterCard® cards. It is contemplated that multiple card networks, and even proprietary card networks of the provider of the blockchain payment apparatus 100, may be supported by the blockchain payment apparatus 100.

It is further contemplated that Person B may wish to load only a portion of the received funds onto a disposable card having a different card number, expiration date, and security code (e.g. card verification value). To this end, with the funds from Person A having been credited to Person B, the operational flow of FIG. 6 may further continue with the blockchain payment apparatus 100 (e.g. the digital payment card generator 140) receiving a token request from Person B with a specific cash amount as selected by Person B using a website or mobile application GUI of the blockchain payment apparatus 100 (step 680). In response to receiving the token request, the digital payment card generator 140 may generate a disposable digital card loaded with the selected cash amount (step 690), for example, by providing the information of the token request to the payment processing platform 500, which may pull a new card number from the BIN range 510. The digital payment card generator 140 may then receive the disposable digital card from the payment processing platform 500, load the selected cash amount on the disposable digital card, and present the disposable digital card to Person B over the GUI on Person B's device 200b. In this way, Person B may spin additional disposable digital cards off of the digital payment card 145 to manage his/her funds as desired.

In the above examples, it is explained that the recipient (Person B in FIG. 1) may be required to register with the provider of the blockchain payment apparatus 100 in order to accept the payment from the sender (Person A). However, the disclosed subject matter is not intended to be so limited. For example, it is contemplated that the blockchain payment apparatus 100 may provide Person B with the digital payment card 145 without requiring Person B to register. In a case where both Person A and Person B begin and end the transaction as unregistered users of the blockchain payment apparatus 100, the blockchain payment apparatus 100 may serve not necessarily as a virtual currency platform or network of users but as a tool for enabling discrete transactions.

Throughout the above examples, it is assumed that the payment made from the sender (Person A in FIG. 1) to the recipient (Person B) is funded by Person A's cryptocurrency on a public blockchain (e.g. Bitcoin) separate and apart from the provider of the blockchain payment apparatus 100. However, it is contemplated that the cryptocurrency may instead be a cryptocurrency offered by the provider of the blockchain payment apparatus 100.

It should also be noted that the disclosed subject matter is not intended to be limited to the above-described situation where the recipient (Person B) receives a newly generated digital payment card 145. For example, the user may instead already have a card issued by a bank or other entity. By using the blockchain payment apparatus 100, Person A (or Person B alone) may utilize the blockchain payment apparatus 100 to load the preexisting card with funds from a cryptocurrency account. Such a use case of the blockchain payment apparatus 100 may be especially useful from the perspective of a bank issuing such preexisting cards, whether the bank acts as the provider of the blockchain payment apparatus 100 or as a third-party thereto. By providing its customers access to the blockchain payment apparatus 100, the bank may offer increased flexibility for loading funds to its own issued cards from diverse sources including cryptocurrency.

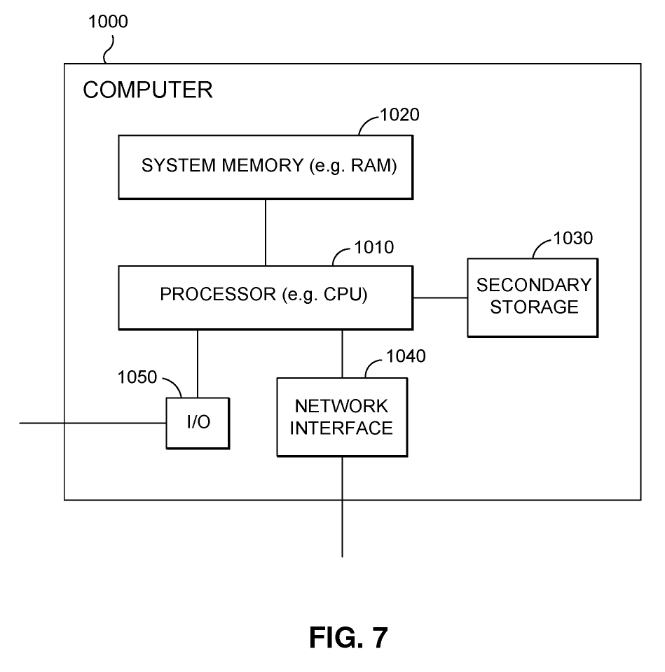

FIG. 7 shows an example of a computer 1000 in which the blockchain payment apparatus of FIG. 1, the operational flows of FIGS. 3, 3A, 3B, and 6, and/or other embodiments of the disclosure may be wholly or partly embodied. As shown in FIG. 7, the computer 1000 may include a processor (e.g. a CPU) 1010, a system memory (e.g. RAM) 1020 that may be connected by a dedicated memory channel to the processor 1010 and temporarily stores results of data processing operations performed by the processor 1010, and a hard drive or other secondary storage device 1030. The processor 1010 may execute one or more computer programs, which may be tangibly embodied along with an operating system in a computer-readable medium, e.g., the secondary storage device 1030. The operating system and computer programs may be loaded from the secondary storage device 1030 into the system memory 1020 to be executed by the processor 1010. The computer 1000 may further include a network interface 1040 for network communication between the computer 1000 and external devices (e.g. over the Internet), such as user devices 200a, 200b accessing the blockchain payment apparatus 100 and associated GUIs described throughout this disclosure using a mobile application or web browser, as well as the cryptocurrency payment processor 300 and/or payment processing platform 500. Server-side user interaction with the computer 1000 may be via one or more I/O devices 1050, such as a display, mouse, keyboard, etc.

The computer programs may comprise program instructions which, when executed by the processor 1010, cause the processor 1010 to perform operations in accordance with the various embodiments of the present disclosure. For example, a program that is installed in the computer 1000 may cause the computer 1000 to function as an apparatus such as the blockchain payment apparatus 100 of FIG. 1, e.g., causing the computer 1000 to function as some or all of the sections, components, elements, databases, engines, interfaces, modules, managers, validators, generators, etc. of the blockchain payment apparatus 100 of FIG. 1 (e.g., the request validator 110, the invoice manager 120, etc.). A program that is installed in the computer 1000 may also cause the computer 1000 to perform an operational flow such as those shown in FIGS. 3, 3A, 3B, and 6 or a portion thereof, e.g., causing the computer 1000 to perform one or more of the steps of FIGS. 3A and 3B (e.g., “UI 1—provide Recipient Information,” “General Velocity Limits Exceeded?,” “BP1—Validate Recipient,” etc., where the computer 1000 may perform the steps labeled “UI” by generating a GUI for the performance of the step) and/or one or more of the steps of FIG. 6 (e.g., receive P2P payment request 610, generate invitation in response to payment of cryptocurrency payment invoice 630, etc.).

The above-mentioned computer programs may be provided to the secondary storage 1030 by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer 1000 via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A non-transitory program storage medium on which are stored instructions executable by a processor or programmable circuit to perform operations for converting cryptocurrency into real, spendable currency, the operations comprising:
receiving, from a first electronic device, a peer-to-peer payment request including a payment amount and a unique identifier of a recipient;
generating a cryptocurrency payment invoice in response to receiving the peer-to-peer payment request;
generating an invitation in response to payment of the cryptocurrency payment invoice, the invitation to be transmitted wirelessly to the recipient using the unique identifier;
receiving, from a second electronic device, an acceptance of the invitation and one or more items of new user information associated with the recipient;
generating a digital payment card in the name of the recipient in response to receiving the acceptance and the new user information, the digital payment card including a card number pulled from a bank identification number (BIN) range; and,
after said generating the digital payment card, crediting the payment amount to the recipient.

2. The non-transitory program storage medium of claim 1, wherein the unique identifier is selected from the group consisting of a phone number, an email address, and a social network ID.

3. The non-transitory program storage medium of claim 1, wherein said generating the cryptocurrency payment invoice includes calling an API associated with a cryptocurrency payment processor.

4. The non-transitory program storage medium of claim 1, wherein said generating the digital payment card includes communicating the received peer-to-peer payment request and new user information to a payment processing platform and receiving the digital payment card from the payment processing platform.

5. The non-transitory program storage medium of claim 1, wherein said crediting the payment amount to the recipient includes loading the payment amount onto the digital payment card.

6. The non-transitory program storage medium of claim 1, wherein the digital payment card is reloadable.

7. The non-transitory program storage medium of claim 6, the operations further comprising:
receiving, from the second electronic device, a token request including a cash amount; and
generating a disposable digital card loaded with the cash amount in response to receiving the token request.

8. The non-transitory program storage medium of claim 7, wherein said generating the disposable digital card includes communicating the received token request to a payment processing platform and receiving the disposable digital card from the payment processing platform.

9. The non-transitory program storage medium of claim 1, further comprising storing a state associated with the cryptocurrency payment invoice in a permissioned blockchain framework.

10. The non-transitory program storage medium of claim 9, wherein the state associated with the cryptocurrency payment invoice includes a paid/unpaid state of the cryptocurrency payment invoice.

11. The non-transitory program storage medium of claim 1, further comprising storing a state associated with the invitation in a permissioned blockchain framework.

12. The non-transitory program storage medium of claim 11, wherein the state associated with the invitation includes an accepted/unaccepted state of the invitation.

13. The non-transitory program storage medium of claim 1, further comprising storing a state associated with the digital payment card in a permissioned blockchain framework.

14. The non-transitory program storage medium of claim 13, wherein the state associated with the digital payment card includes an amount loaded onto the digital payment card.

15. A method for converting cryptocurrency into real, spendable currency, the method comprising:
receiving, from a first electronic device, a peer-to-peer payment request including a payment amount and a unique identifier of a recipient;
generating a cryptocurrency payment invoice in response to receiving the peer-to-peer payment request;
generating an invitation in response to payment of the cryptocurrency payment invoice, the invitation to be transmitted wirelessly to the recipient using the unique identifier;
receiving, from a second electronic device, an acceptance of the invitation and one or more items of new user information associated with the recipient;
generating a digital payment card in the name of the recipient in response to receiving the acceptance and the new user information, the digital payment card including a card number pulled from a bank identification number (BIN) range; and,
after said generating the digital payment card, crediting the payment amount to the recipient.

16. The method of claim 15, wherein the unique identifier is selected from the group consisting of a phone number, an email address, and a social network ID.

17. A system for converting cryptocurrency into real, spendable currency, the system comprising:
a first electronic device that wirelessly transmits a peer-to-peer payment request including a payment amount and a unique identifier of a recipient;
one or more servers that receive the peer-to-peer payment request, generate a cryptocurrency payment invoice in response to receiving the peer-to-peer payment request, and generate an invitation in response to payment of the cryptocurrency payment invoice, the invitation to be transmitted wirelessly to the recipient using the unique identifier; and
a second electronic device that receives the invitation and wirelessly transmits an acceptance of the invitation and one or more items of new user information associated with the recipient;
wherein the one or more servers receive the acceptance and the new user information, generate a digital payment card in the name of the recipient in response to receiving the acceptance and the new user information, and, after generating the digital payment card, credit the payment amount to the recipient;
wherein the digital payment card includes a card number pulled from a bank identification number (BIN) range.

18. The system of claim 17, wherein the unique identifier is selected from the group consisting of a phone number, an email address, and a social network ID.

19. The system of claim 17, further comprising:
a cryptocurrency payment processor;
wherein the one or more servers generates the cryptocurrency payment invoice by calling an API associated with the cryptocurrency payment processor.

20. The system of claim 17, wherein the one or more servers comprises a permissioned blockchain framework.
